(19) United States
(12) Patent Application Publication
(10) Pub. No.: US 2008/0259718 A1
(43) Pub. Date: Oct. 23, 2008

(54) Stirrer for introducing a particulate material into a liquid

(76) Inventors: Mujgan Agardici, Ossining, NY (US); Mustafa Agardici, Ossining, NY (US)

Correspondence Address: MILDE & HOFFBERG, LLP, 10 BANK STREET, SUITE 460, WHITE PLAINS, NY, 10606, US

(21) Appl. No.: 11/895,229

(22) Filed: Aug. 23, 2007

Related U.S. Application Data
(60) Provisional application No. 60/925,396, filed on Apr. 20, 2007.

(51) Int. Cl. B01F 13/00

(52) U.S. Cl. 366/129

(57) ABSTRACT

A stirrer for introducing a particulate material into a liquid is provided. Said stirrer includes a first hollow rod and a second hollow rod surrounding said first hollow rod. Said first hollow rod is adapted for holding said particulate material, and has one or more holes for introducing said particulate material into said liquid. Said second hollow rod is movable between a first position and a second position. Said second hollow rod covers said holes in said first position, and uncovers said holes in said second position, whereby said particulate material is introduced into said liquid in said second position.

### BACKGROUND OF THE INVENTION

The present invention relates, in general, to stirrers. More specifically, the present invention relates to a stirrer for introducing a particulate material into a liquid.

Typically a stirrer is used for stirring a particulate material into a liquid. For example, the stirrer is used for dissolving a particulate material such as sugar in a beverage. Said particulate material is often stored in a container. A user takes out a desired amount of said particulate material using a spatula, and introduces it into said liquid. Said particulate material often gets spilled in this process. Therefore, it is desirable to provide a stirrer disposed with a particulate material to be introduced into a liquid.

Various stirrers have been known in the art. In one example of known stirrers, the particulate material is held inside a hollow body of a stirrer. Such stirrer has one or more holes so that when said stirrer is inserted into a liquid, said liquid enters said hollow body of said stirrer. Thereafter, said particulate material dissolves into said liquid. In some examples, such a stirrer is covered with a sleeve that may cover and uncover said holes. However, said particulate material may clog said holes, thereby rendering said stirrer unusable. In addition, said stirrers may leak after use, making it difficult to cleanly remove said stirrers from said liquid.

In another example, a particulate material is coated over a stirrer. Said stirrer is inserted into a liquid, thereby said particulate material is introduced into said liquid. However, such coatings of said particulate material may take more time to dissolve as compared to a particulate material in a granular form. Moreover, such coatings are often sticky, and need proper packaging to avoid wastage and/or any contamination.

In light of the foregoing discussion, there is a need for a stirrer to introduce a particulate material into a liquid that is easy to store, use, and remove after use.

### SUMMARY OF THE INVENTION

An object of the present invention is to provide a stirrer for introducing a particulate material into a liquid.

Another object of the present invention is to make said stirrer easy to store, use, and remove after use.

Embodiments of the present invention provide a stirrer for introducing a particulate material into a liquid. Said stirrer includes a first hollow rod and a second hollow rod surrounding said first hollow rod. Said first hollow rod is adapted for holding said particulate material. Said first hollow rod has a first end, a second end, and one or more holes for introducing said particulate material into said liquid. Said holes are adjacent to said second end. Said stirrer includes a knob configured to be attached with said first end, and a cover for closing said second end. Said knob is adapted to be gripped by said user. Said second hollow rod is adapted to be gripped and moved by said user. Said second hollow rod is movable between a first position and a second position. Said second hollow rod covers said holes in said first position, and uncovers said holes in said second position, so that said particulate material is introduced into said liquid in said second position. In an embodiment of the present invention, said second hollow rod is in effective sealing contact with said first hollow rod.

Said stirrer is stored with said second hollow rod in said first position. For use, said second hollow rod is moved towards said second position, whereby said holes are uncovered. Subsequently, said particulate material passes out from said holes, and is introduced into said liquid. Meanwhile, said second end of said first hollow rod is inserted into said liquid for stirring said liquid. After use, said second hollow rod may be moved back to said first position, to avoid any leakage from said first hollow rod. These features make said stirrer easy to store, use, and remove after use.

### BRIEF DESCRIPTION OF DRAWINGS

Embodiments of the present invention will hereinafter be described in conjunction with the appended drawings provided to illustrate and not to limit the present invention, wherein like designations denote like elements, and in which:

FIGS. 1a and 1b depict a stirrer for introducing a particulate material into a liquid, in accordance with an embodiment of the present invention;

FIG. 2 depicts how said particulate material is introduced into said liquid, in accordance with an embodiment of the present invention;

FIG. 3 depicts various components of said stirrer, in accordance with an embodiment of the present invention;

FIG. 4 depicts an elliptical cross-sectional shape of a first hollow rod and a second hollow rod of said stirrer, in accordance with an embodiment of the present invention;

FIG. 5 depicts an elliptical cross-sectional shape of said first hollow rod and said second hollow rod, in accordance with another embodiment of the present invention;

FIG. 6a depicts a top view of said stirrer, and FIG. 6b depicts a front view of said stirrer, when said second hollow rod is in a first position, in accordance with an embodiment of the present invention;

FIG. 7a depicts a front view of said stirrer, when said second hollow rod is in a second position, and FIG. 7b depicts a bottom view of said stirrer, in accordance with an embodiment of the present invention;

FIG. 8a depicts how said various components of said stirrer are to be arranged, and FIG. 8b depicts said stirrer when its components are arranged together, in accordance with an embodiment of the present invention;

FIG. 9 depicts said stirrer, in accordance with another embodiment of the present invention; and

FIG. 10 depicts how said particulate material is delivered into said liquid, in accordance with another embodiment of the present invention.

### DETAILED DESCRIPTION OF THE PREFERRED EMBODIMENTS

Embodiments of the present invention provide a stirrer for introducing a particulate material into a liquid. In the description herein for embodiments of the present invention, numerous specific details are provided, such as examples of components and/or mechanisms, to provide a thorough understanding of embodiments of the present invention. One skilled in the relevant art will recognize, however, that an embodiment of the present invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

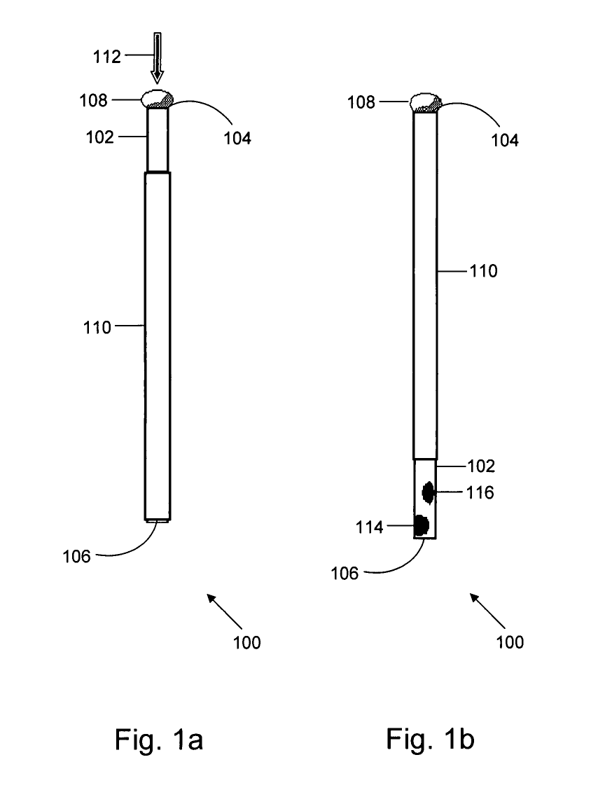

FIGS. 1a and 1b depict a stirrer 100 for introducing a particulate material into a liquid, in accordance with an embodiment of the present invention. Stirrer 100 includes a first hollow rod 102 having a first end 104 and a second end 106, a knob 108 configured to be attached with first end 104, and a second hollow rod 110 surrounding first hollow rod 102. An arrow 112 indicates a direction in which knob 108 may be pushed to move first hollow rod 102 with respect to second hollow rod 110, in accordance with an embodiment of the present invention. First hollow rod 102 is adapted for holding said particulate material, and has one or more holes for introducing said particulate material into said liquid, such as a hole 114 and a hole 116.

First end 104 of first hollow rod 102 is adapted to be held by a user. Hole 114 and hole 116 are adjacent to second end 106, which is adapted for insertion into said liquid. Knob 108 is adapted to be gripped by said user. In accordance with an embodiment of the present invention, knob 108 has a cross-sectional area greater than a cross-sectional area of first hollow rod 102.

Second hollow rod 110 is adapted to be gripped and moved by said user. Second hollow rod 110 is movable between a first position and a second position. In said first position, second hollow rod 110 covers hole 114 and hole 116. In said second position, second hollow rod 110 uncovers hole 114 and hole 116. FIG. 1a depicts second hollow rod 110 in said first position, while FIG. 1b depicts second hollow rod 110 in said second position. In accordance with an embodiment of the present invention, second hollow rod 110 is in effective sealing contact with first hollow rod 102. As mentioned earlier, first hollow rod 102 and second hollow rod 110 are movable with respect to each other. First hollow rod 102 may be moved by pushing knob 108, while second hollow rod 110 is held by said user. Alternatively, knob 108 may be held by said user, while second hollow rod 110 is slidably moved over first hollow rod 102.

It is to be understood that the specific designation for stirrer 100 is for the convenience of the reader and is not to be construed as limiting stirrer 100 to a specific size, shape, number, or arrangement of its components.

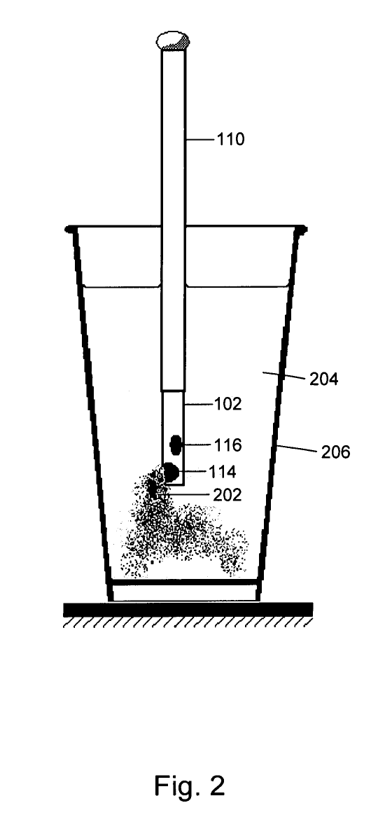

FIG. 2 depicts how a particulate material 202 is introduced into a liquid 204, in accordance with an embodiment of the present invention. Liquid 204 is contained in a container 206. First hollow rod 102 is used to introduce particulate material 202 in liquid 204. Particulate material 202 includes a plurality of granules smaller in size than hole 114 and/or hole 116, in accordance with an embodiment of the present invention. It should be noted that particulate material 202 may, for example, be in the form of a liquid.

Stirrer 100 is stored with second hollow rod 110 in said first position. For use, second hollow rod 110 is moved towards said second position to uncover hole 114 and hole 116. Particulate material 202 passes out from hole 114 and/or hole 116, and is introduced into liquid 204. In accordance with an embodiment of the present invention, particulate material 202 passes out from hole 114, while air passes in through hole 116. Meanwhile, second end 106 of first hollow rod 102 is inserted into liquid 204 for stirring liquid 204. After use, second hollow rod 110 may be moved back to said first position, in order to avoid any leakage from first hollow rod 102.

In accordance with an embodiment of the present invention, first hollow rod 102 is disposed with a predefined amount of particulate material 202. It should be noted that stirrers with different amounts of particulate material 202 may be employed, and marked with appropriate labels to indicate the amount of particulate material 202 provided.

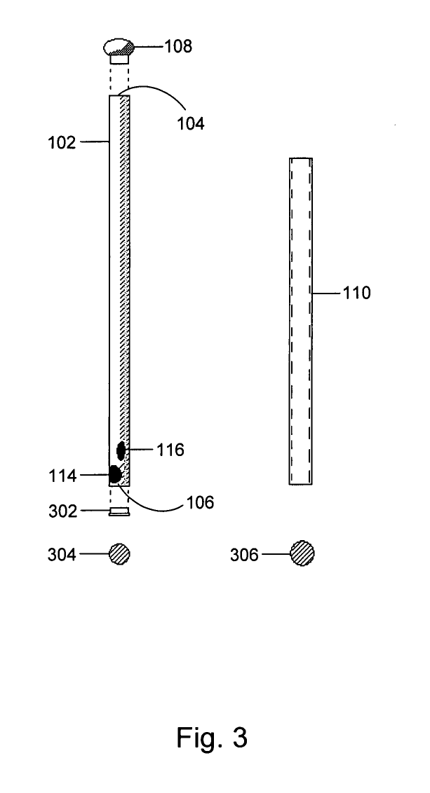

FIG. 3 depicts various components of stirrer 100, in accordance with an embodiment of the present invention. Apart from first hollow rod 102, knob 108 and second hollow rod 110, stirrer 100 includes a cover 302 for closing second end 106 of first hollow rod 102. With reference to FIG. 3, first hollow rod 102 has a circular cross-sectional shape 304, and second hollow rod 110 has a circular cross-sectional shape 306.

First hollow rod 102 and second hollow rod 110 may be of any suitable size and shape. In accordance with an embodiment of the present invention, the length of second hollow rod 110 is less than the length of first hollow rod 102. In accordance with an embodiment of the present invention, the cross-sectional shape of first hollow rod 102 is substantially the same as the cross-sectional shape of second hollow rod 110. The cross-sectional shape of first hollow rod 102 and second hollow rod 110 may be, for example, a closed curved cross-sectional shape, a closed angular cross-sectional shape, or a combination thereof. Examples of said closed curved cross-sectional shape include, but are not limited to, a circular cross-sectional shape, an elliptical cross-sectional shape, and a bean cross-sectional shape. Examples of said closed angular cross-sectional shape include, but are not limited to, a rectangular cross-sectional shape, a square cross-sectional shape, a triangular cross-sectional shape, a parallelepiped cross-sectional shape, and a polygonal cross-sectional shape. Examples of said combination cross-sectional shape include, but are not limited to, a semi-circular cross-sectional shape, a concavo-concave cross-sectional shape, and a convexo-convex cross-sectional shape.

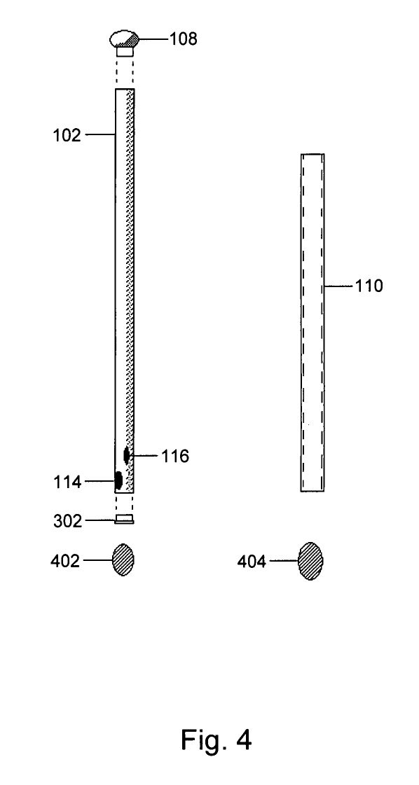

FIG. 4 depicts an elliptical cross-sectional shape of first hollow rod 102 and second hollow rod 110, in accordance with an embodiment of the present invention. With reference to FIG. 4, first hollow rod 102 has an elliptical cross-sectional shape 402, second hollow rod 110 has an elliptical cross-sectional shape 404, and hole 114 and hole 116 are made on a narrower side of first hollow rod 102.

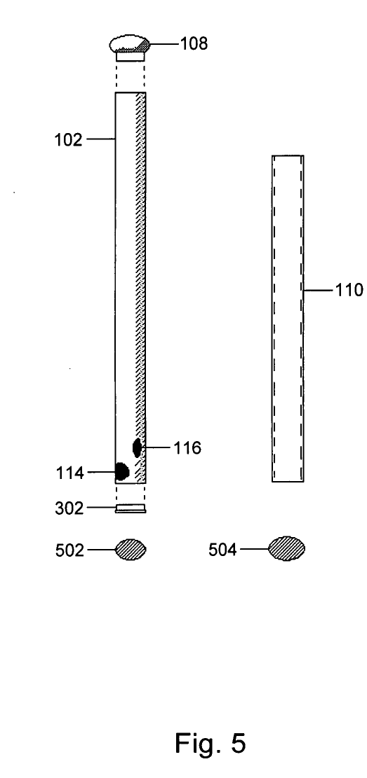

FIG. 5 depicts an elliptical cross-sectional shape of first hollow rod 102 and second hollow rod 110, in accordance with another embodiment of the present invention. With reference to FIG. 5, first hollow rod 102 has an elliptical cross-sectional shape 502, second hollow rod 110 has an elliptical cross-sectional shape 504, and hole 114 and hole 116 are made on a broader side of first hollow rod 102.

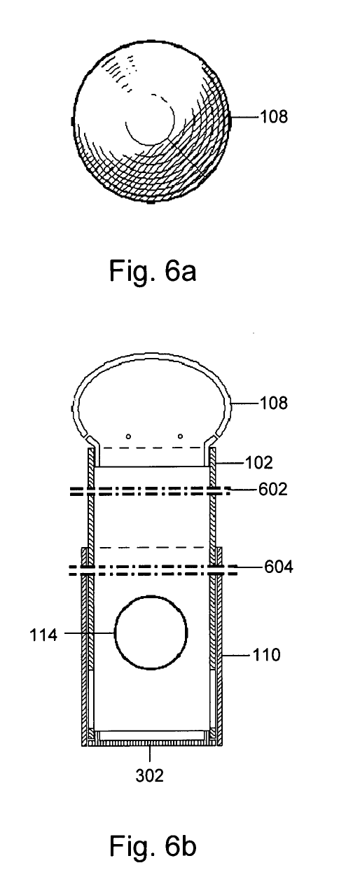

FIG. 6a depicts a top view of stirrer 100, and FIG. 6b depicts a front view of stirrer 100, when second hollow rod 110 is in said first position, in accordance with an embodiment of the present invention. It should be noted that a portion of stirrer 100 between double broken lines 602 and double broken lines 604 is not to scale.

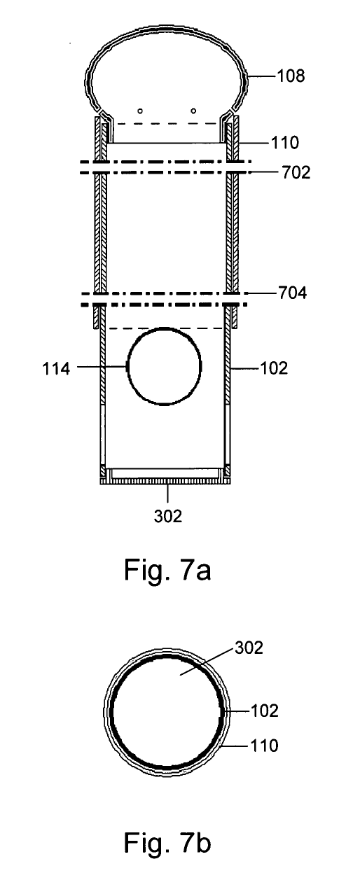

FIG. 7a depicts a front view of stirrer 100, when second hollow rod 110 is in said second position, and FIG. 7b depicts a bottom view of stirrer 100, in accordance with an embodiment of the present invention. It should be noted that a portion of stirrer 100 between double broken lines 702 and double broken lines 704 is not to scale.

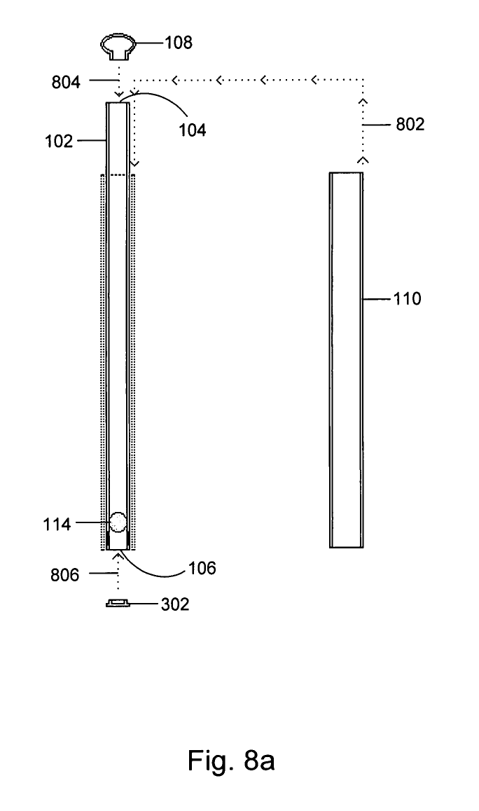

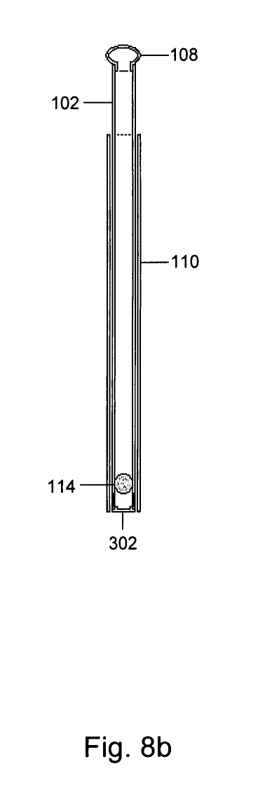

FIG. 8a depicts how said various components of stirrer 100 are to be arranged, in accordance with an embodiment of the present invention. An arrow 802 indicates how second hollow rod 110 is to be arranged over first hollow rod 102. An arrow 804 indicates how knob 108 is to be arranged to close first end 104 of first hollow rod 102, while an arrow 806 indicates how cover 302 is to be arranged to close second end 106 of first hollow rod 102.

FIG. 8b depicts stirrer 100 when first hollow rod 102, knob 108, cover 302 and second hollow rod 110 are arranged together, in accordance with an embodiment of the present invention.

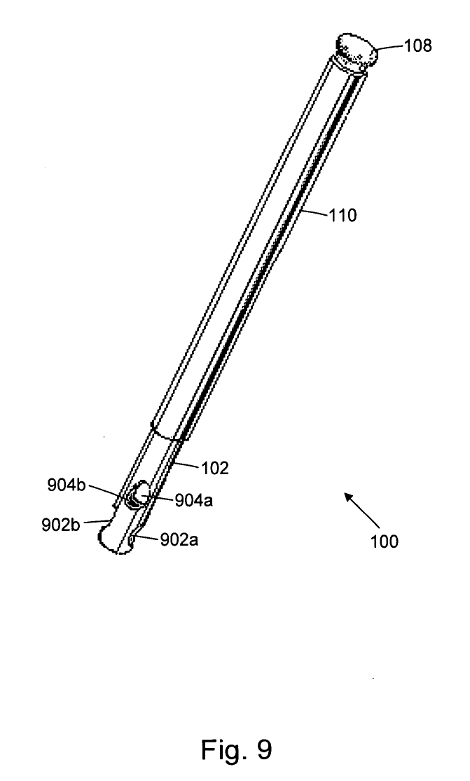

FIG. 9 depicts stirrer 100, in accordance with another embodiment of the present invention. With reference to FIG. 9, first hollow rod 102 has two holes adjacent to second end 106 of first hollow rod 102, such as a hole 902a and a hole 902b. In addition, first hollow rod 102 has two holes for air to pass through, such as a hole 904a and a hole 904b. Hole 902a and hole 902b are opposite to each other, so that liquid entering one may pass out through another. Similarly, hole 904a and hole 904b are opposite to each other.

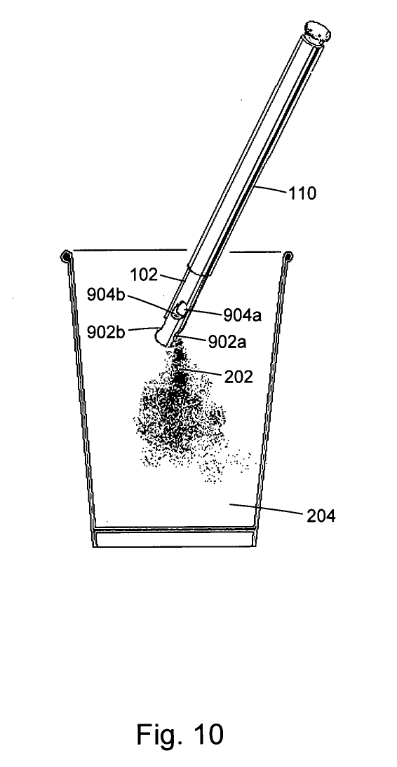

FIG. 10 depicts how particulate material 202 is delivered into liquid 204, in accordance with another embodiment of the present invention. Particulate material 202 passes out from hole 902a, while liquid 204 passes through hole 902a and hole 902b. Meanwhile, air passes out through hole 904a and hole 904b.

In accordance with an embodiment of the present invention, stirrer 100 is a beverage stirrer, wherein particulate material 202 is a beverage material and liquid 204 is a beverage. Examples of the beverage material include, but are not limited to, sugar, milk powder, coffee powder, tea leaves, cocoa powder, lemon flavor, and the like. Examples of the beverage include, but are not limited to, water, milk, coffee, tea, alcoholic drink, fruit juice, and the like.

In accordance with an embodiment of the present invention, stirrer 100 is made of a non-toxic material. Stirrer 100 may, for example, be made of a tasteless, odorless, moisture-resistant material such as plastics, metal, glass, wood, paper, and porcelain. Further, stirrer 100 may be either disposable or reusable.

Stirrer 100 may, for example, be used in chemical laboratories, wherein particulate material 202 is a solute and liquid 204 is a solvent. Depending on the purpose for which stirrer 100 is to be used, stirrer 100 may be made of a suitable material. For example, for use in a chemistry laboratory, stirrer 100 may be made of glass or any other material that does not react with the solute and/or the solvent.

Embodiments of the present invention provide stirrer 100 for introducing a particulate material into a liquid. Stirrer 100 is self-contained, and does not require additional tools during use.

Stirrer 100 is easy to store, use, and remove after use. Stirrer 100 is stored with second hollow rod 110 in said first position. Knob 108 and second hollow rod 110 are adapted to be gripped by a user, thereby enabling easy handling of stirrer 100. Knob 108 and second hollow rod 110 are easily coordinated to cover and uncover holes on first hollow rod 102. Further, there is no leakage from first hollow rod 102, after use, as second hollow rod 110 covers said holes and seals first hollow rod 102 effectively.

While embodiments of the present invention have been illustrated and described, it will be clear that the present invention is not limited to these embodiments only. Numerous modifications, changes, variations, substitutions and equivalents will be apparent to those skilled in the art, without departing from the spirit and scope of the present invention, as described in the claims.

What is claimed is:

1. A stirrer for introducing a particulate material into a liquid, the stirrer comprising:
a) a first hollow rod adapted for holding said particulate material, said first hollow rod comprising:
i) a first end adapted to be held by a user;
ii) a second end adapted for insertion in said liquid; and
iii) one or more holes for introducing said particulate material, wherein said holes are adjacent to said second end;
b) a knob configured to be attached with said first end of said first hollow rod, said knob being adapted to be gripped by said user;
c) a cover for closing said second end of said first hollow rod; and
d) a second hollow rod surrounding said first hollow rod, said second hollow rod being movable between a first position and a second position, wherein said second hollow rod covers said holes in said first position, and uncovers said holes in said second position, wherein said particulate material is introduced in said liquid in said second position.

2. The stirrer according to claim 1, wherein said first hollow rod is disposed with a predefined amount of said particulate material.

3. The stirrer according to claim 1, wherein said second hollow rod is adapted to be gripped and moved by said user.

4. The stirrer according to claim 1, wherein length of said second hollow rod is less than length of said first hollow rod.

5. The stirrer according to claim 1, wherein said stirrer is made of a non-toxic material.

6. The stirrer according to claim 1, wherein said particulate material is a beverage material.

7. A beverage stirrer for introducing a beverage material into a beverage, said beverage stirrer comprising:
a) a first hollow rod for holding said beverage material comprising:
i) a first end adapted to be held by a user;
ii) a second end adapted for insertion in said liquid; and
iii) one or more holes for introducing said beverage material, wherein said holes are adjacent to said second end;
b) a knob configured to be attached with said first end of said first hollow rod, said knob being adapted to be gripped by said user;
c) a cover for closing said second end of said first hollow rod; and
d) a second hollow rod surrounding said first hollow rod, said second hollow rod being movable between a first position and a second position, wherein said second hollow rod covers said holes in said first position, and uncovers said holes in said second position, wherein said beverage material is introduced in said beverage in said second position.

8. The beverage stirrer according to claim 7, wherein said first hollow rod is disposed with a predefined amount of said beverage material.

9. The beverage stirrer according to claim 7, wherein said second hollow rod is adapted to be gripped and moved by said user.

10. The beverage stirrer according to claim 7, wherein length of said second hollow rod is less than length of said first hollow rod.

11. The beverage stirrer according to claim 7, wherein said beverage stirrer is made of a non-toxic material.
